(19) United States
(12) Patent Application Publication
(10) Pub. No.: US 2026/0251108 A1
(43) Pub. Date: Aug. 27, 2026

(54) MOVABLE DIAPHRAGM BIDIRECTIONAL NOISE REDUCTION CANNISTER VENT SOLENOID (CVS) VALVE

(71) Applicants: STONERIDGE, INC., Novi, MI (US); Stoneridge Asia-Pacific Electronics (Suzhou) Co. Ltd., Jiangsu PR (CN)

(72) Inventors: Gavin Chen, Jiangsu PR (CN); Sean Gao, Jiangsu PR (CN); Terry Yu, Jiangsu PR (CN)

(21) Appl. No.: 19/078,489

(22) Filed: Mar. 13, 2025

(30) Foreign Application Priority Data
Feb. 25, 2025 (CN) 202510209358.3

(51) Int. Cl. F02M 25/08; F16K 31/06; F16K 41/10

(52) U.S. Cl. CPC F02M 25/0836; F16K 31/0655; F16K 41/10; F02M 2025/0845

(57) ABSTRACT

A solenoid valve is provided generally including a bobbin for supporting a coil. A plunger is coupled to the armature and is movable with the armature. An elastomeric diaphragm includes an opening through which a longitudinal shaft of the plunger passes freely. A radially extending flange on the longitudinal shaft contacts the diaphragm when plunger is moving to a closed position to reduce the speed of the plunger and reduce audible noise. The plunger also contacts the diaphragm when moving to an open position to reduce the speed of the plunger and reduce audible noise.

### TECHNICAL FIELD

The present disclosure is generally directed to solenoid valves, and, in particular, to a movable diaphragm bidirectional noise reduction solenoid valve.

### BACKGROUND

Solenoids are used in a myriad of applications in the automotive industry. For example, solenoids may be used for high power switches with a lower power control signal. Solenoids are also used in automated or remote valves, such as a canister vent solenoid valve associated with evaporative emission control systems. Such solenoid valves may be used to control the flow of a variety of fluids. For example, in the context of a canister vent solenoid valve, the solenoid valve may be used to control the flow of fuel vapors into a charcoal canister. Solenoid valves may be similarly used to control the flow of liquids and vapors for other vehicle systems.

During operation of a solenoid valve, an armature may move a seal on a plunger to engage and disengage a valve seat. Generally, when the seal is engaged with the valve seat the solenoid valve is in a closed condition, and when the seal is disengaged from the valve seat the solenoid valve is in an opened condition. The opening and closing of the solenoid valve may create various audible noises. For example, when the valve is closed, the seal may impact against the valve seat, creating audible noise. Similarly, when the valve is opened, the armature may impact a portion or the bobbin, thereby creating a clicking noise. The audible noises associated with the various mechanical components of a motor vehicle are often considered undesirable, and the elimination of such audible noise may generally be considered to be beneficial.

### BRIEF DESCRIPTION OF THE DRAWINGS

Features of the present embodiments will be understood better by reading the following detailed description, taken together with the figures herein described. The accompanying drawings are not intended to be drawn to scale. In the drawings, each identical or nearly identical component that is illustrated in various figures may be represented by a like numeral. For purposes of clarity, not every component may be labeled in every drawing.

FIG. 1 is an isometric view of one example of a solenoid valve consistent with the present disclosure.

FIG. 2 is an exploded view of the solenoid valve shown in FIG. 1.

FIG. 3 is a side sectional view of the solenoid valve shown in FIG. 1 with the solenoid vale in a deenergized state and a plunger in an open position.

FIG. 4A is a side sectional view of the diaphragm of the solenoid valve shown in FIG. 1.

FIG. 4B is top perspective view of the diaphragm of the solenoid valve shown in FIG. 1.

FIG. 4C is a side view of the diaphragm of the solenoid valve shown in FIG. 1.

FIG. 4D is a top view of the diaphragm of the solenoid valve shown in FIG. 1.

FIG. 4E is a bottom view of the diaphragm of the solenoid valve shown in FIG. 1.

FIG. 5 is a side sectional perspective view of the plunger and the diaphragm of the solenoid valve shown in FIG. 1.

FIG. 6 is a close-up side sectional view of the opening in the diaphragm of the solenoid valve shown in FIG. 1 and a portion of the longitudinal shaft of the plunger of the solenoid valve shown in FIG. 1 disposed in the opening showing a gap between the diaphragm and the longitudinal shaft of the plunger.

FIG. 7 is a close-up top sectional view of the opening in the diaphragm of the solenoid valve shown in FIG. 1 and a portion of the longitudinal shaft of the plunger of the solenoid valve shown in FIG. 1 disposed in the opening showing a gap between the diaphragm and the longitudinal shaft of the plunger.

FIG. 8 is a close-up side sectional view of the solenoid valve shown in FIG. 1 with the solenoid vale in a deenergized state and a plunger in an open position.

FIG. 9 is a side sectional view of the solenoid valve shown in FIG. 1 with the solenoid vale in an energized state and a plunger in a closed position.

FIG. 10 includes plots of the sound level in decibels (db) for both a solenoid valve consistent with the present disclosure and a prior art solenoid valve in both energized and deenergized states.

FIG. 11 diagrammatically illustrates one example of an evaporative emissions system including a solenoid valve consistent with the present disclosure.

### DETAILED DESCRIPTION

The present disclosure is not limited in its application to the details of construction and the arrangement of components set forth in the following description or illustrated in the drawings. The examples described herein may be capable of other embodiments and of being practiced or being carried out in various ways. Also, the phraseology and terminology used herein is for the purpose of description and should not be regarded as limiting as such may be understood by one of skill in the art. Throughout the present description, like reference characters may indicate like structure throughout the several views, and such structure need not be separately discussed. Furthermore, any particular feature(s) of a particular exemplary embodiment may be equally applied to any other exemplary embodiment(s) of this specification as suitable. In other words, features between the various exemplary embodiments described herein are interchangeable, and not exclusive.

In general, the present disclosure is directed to a solenoid valve having reduced audible operating noise. Particularly, a solenoid valve consistent with the present disclosure may include a diaphragm configured to reduce audible noise associated with moving components of the solenoid valve impacting against other components during the operation of the solenoid valve. For example, a diaphragm may be provided to reduce the audible noise associated with one or more of a valve seal striking a valve seat during closing of the valve, an armature striking a bobbin or a stop during opening of the valve, impact between a plunger and the armature during either opening or closing of the valve, etc. While the description herein is set forth in the context of a solenoid valve, such as a canister vent solenoid valve, a solenoid valve consistent with the present disclosure may be provided in any application where noise reduction is desired and is not limited to use as a canister vent solenoid valve.

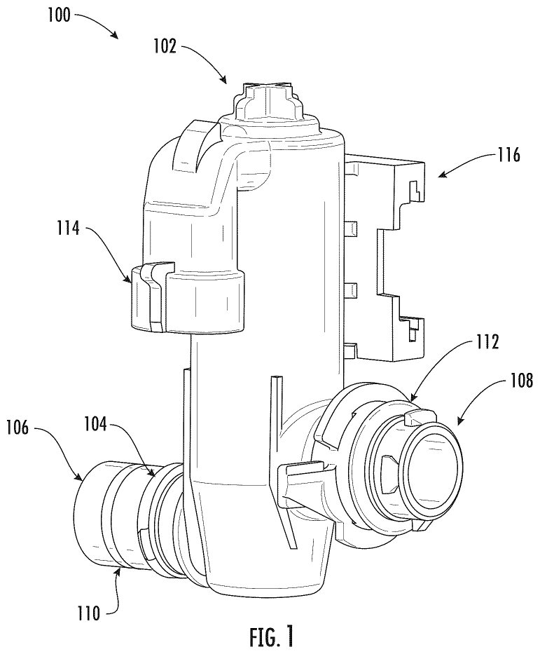

FIG. 1 is a perspective view of one example of a solenoid valve 100 consistent with the present disclosure. In the illustrated example embodiment, the solenoid valve 100 includes a housing 102 that at least partially encompasses a valve body 104. The valve body 104 defines first 106 and second 108 ports, which may be configured with connection features for connecting to associated conduits, e.g., hoses, pipes, etc. A first O-ring 110 may be provided on the first port 106 for sealing a connection between the first port 106 and an associated conduit coupled thereto. A second O-ring 112 may be provided on the second port 108 for sealing a connection between the second port 108 and an associated conduit coupled thereto. In the illustrated example, the housing 102 also includes an electrical connector 114 for receiving input electrical power, e.g. 12 volt(V) power from a vehicle bus. The housing 102 also includes a mounting bracket 116 for mounting the solenoid valve 100 to a fixed location.

Although the illustrated example embodiment 100 includes two ports 106, 108, it is to be understood that solenoid valve 100 consistent with the present disclosure may include any number of ports, depending on the application. Also, the electrical connector 114 and the mounting bracket 116 may be provided in any configuration useful in the application. The example embodiments are shown and described herein by way of explanation, not of limitation.

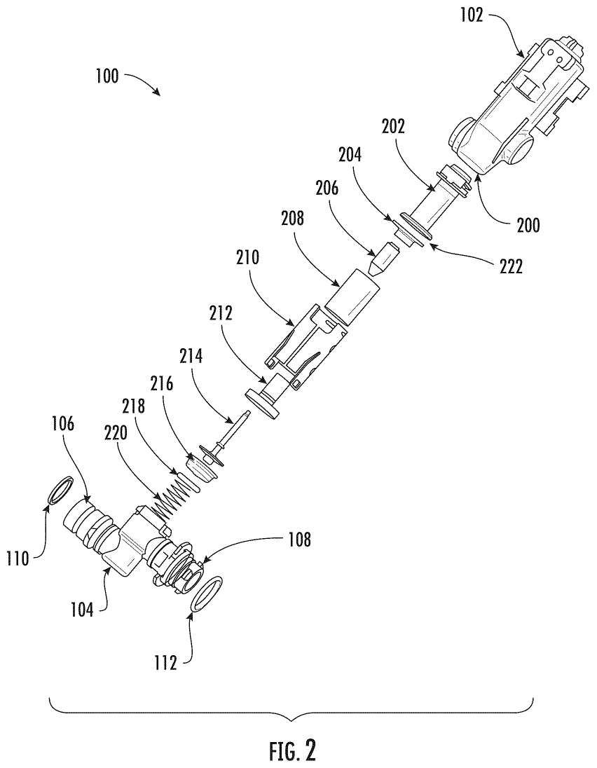

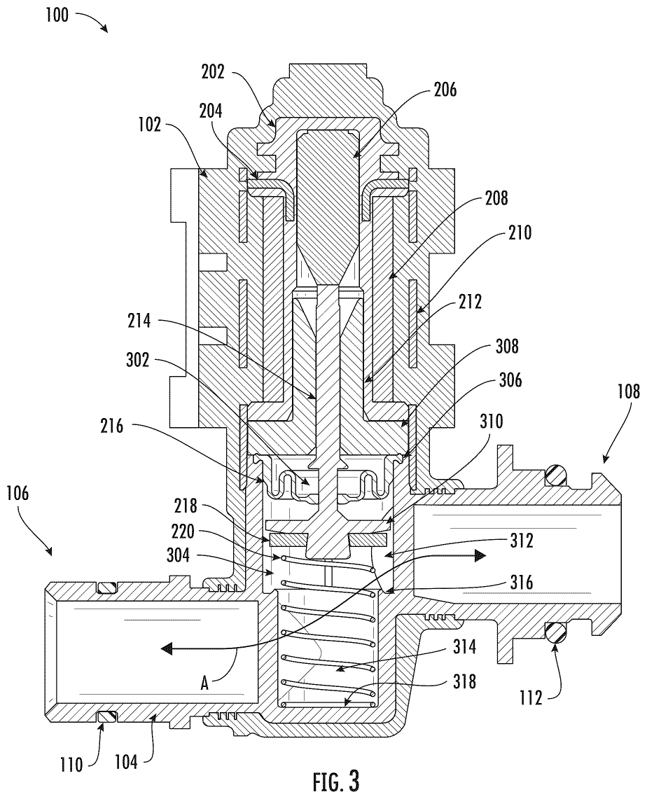

FIG. 2 is an exploded view of the solenoid valve 100 and FIG. 3 is a cross-sectional view of the solenoid valve 100. As shown, the housing 102 includes an interior cavity 200 with a bobbin 202, a top plate 204, an armature 206, a coil 208, a bracket 210, a core 212, a plunger 214, a diaphragm 216, a seal 218, a spring 220, and the valve body 104 at least partially disposed in the interior cavity 200. In the illustrated example, the bracket 210 is disposed in a fixed position in the interior cavity 200 and a least a portion of the bobbin 202, the top plate 204, the armature 206, the coil 208, the core 212, the plunger 214 and the diaphragm 216 are disposed in a cavity defined by the bracket 210.

The bobbin 202 has a top, a bottom and a central opening 222 therethrough. The coil 208 is wrapped, in a known manner, circumferentially around the exterior surface of the bobbin 202 and is coupled to contacts (not shown) in the electrical connector 114. The coil 208 may be a conductive wire such as a copper wire. Connection of electrical power, e.g., through the electrical connector 114, energizes the coil 208 and places the solenoid valve 100 in an energized state and disconnection of the electrical power places the solenoid valve 100 in a deenergized state. The core 212 and the top plate 204 may at least partially extend into the central opening 222 in the bobbin 202 at the bottom and top of the bobbin 202, respectively. Other configurations may also suitably be employed.

The armature 206 may be disposed within the central opening 222 of the bobbin 202 for movement with respect to the bobbin 202, the core 212 and the top plate 204. The bottom of the armature 206 may be coupled to the top of the plunger 214, such that the movement of the armature 206 causes corresponding movement of the plunger 214. Such an arrangement does not, however, require the armature 206 to be directly coupled to the plunger 214.

The plunger 214 extends through an opening 302 in the diaphragm 216 and is movable with respect to the diaphragm 216. The valve body 104 includes a central cavity 304 disposed between the first 106 and second 108 ports. The plunger 214 and the diaphragm 216 extend into a central cavity 304 of the valve body 104. In the illustrated example embodiment 100, the diaphragm 216 has a top flange 306 that is downwardly oriented and extends outwardly. The end of the diaphragm 216 is disposed in an associated groove formed in a top of the valve body 104. The top flange 306 of the diaphragm 216 is captured between the top the valve body 104 and a bottom of a radially extending bottom flange 308 of the core 212 and is thus disposed in a fixed position relative to the plunger 214. The radially extending bottom flange 308 of the core 212 is captured between the bottom of the bobbin 202 and the top of the valve body 104.

The plunger 214 includes a planar bottom flange 310 that extends outwardly adjacent a bottom thereof and a seal 218 is coupled to the bottom of the planar bottom flange 310. The central cavity 304 of the valve body 104 has a top portion 312 with a first dimension at a top thereof for slidably receiving the plunger 214 and the seal 218 and has a bottom portion 314 with a second dimension smaller than the first dimension at a bottom thereof. A valve seat 316 is defined at a transition between the top portion 312 and the bottom portion 314 of the central cavity 304 and is generally configured as an inwardly extending shelf in the central cavity 304.

The plunger 214 is configured to move downwardly in the central cavity 304 until the seal 218 is seated against the valve seat 316. The spring 220 may be configured as a compression spring 220 and is disposed between a bottom of the central cavity 304 and the bottom 318 of the plunger 214. The compression spring 220 biases the plunger 214 upward, urging the seal 218 away from the valve seat 316.

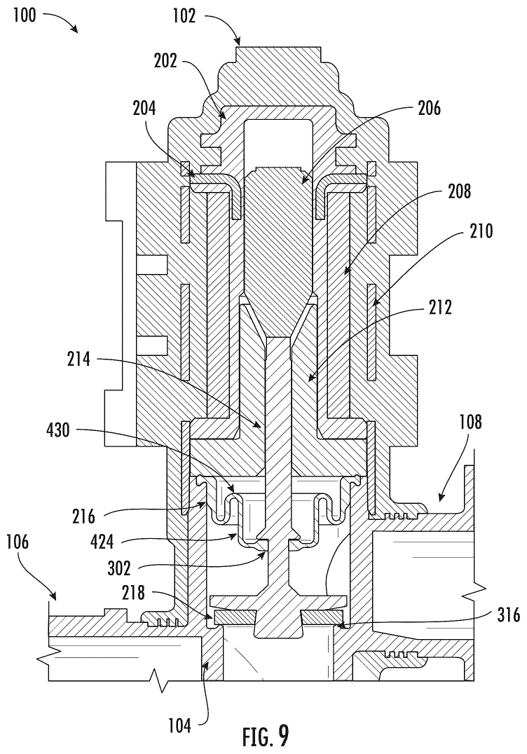

When the seal 218 is seated against the valve seat 316, the plunger 214 is in a closed position (shown in FIG. 9) and fluid communication between the first port 106 and the second port 108 is blocked by the plunger 214 and the seal 218. When the seal 218 is withdrawn from the valve seat 316, as shown in FIG. 3, the plunger 214 is in an open position wherein bi-directional fluid communication between the first 106 and second 108 ports is allowed as indicated by the bi-directional arrow A. In the illustrated example embodiment, the spring 220 biases the plunger 214 toward the open position.

When the solenoid valve 100 is in a deenergized state the plunger 214 is in an open position due to the bias of the spring 220. In the illustrated example embodiment, in the open position the top of the armature 206 is positioned adjacent or in contact with the top of the bobbin 202. When the solenoid valve 100 is in an energized state, the coil 208 induces a magnetic field in the core 212 which moves the plunger 214 and the seal 218 downwardly against the bias of the spring 220 to seat the seal 218 against the valve seat 316 and place the solenoid valve 100 in the closed position. In other embodiments, the plunger 214 may be configured to be in an open position when the solenoid valve 100 is in the energized state and in a closed position when the solenoid valve 100 is in the deenergized state.

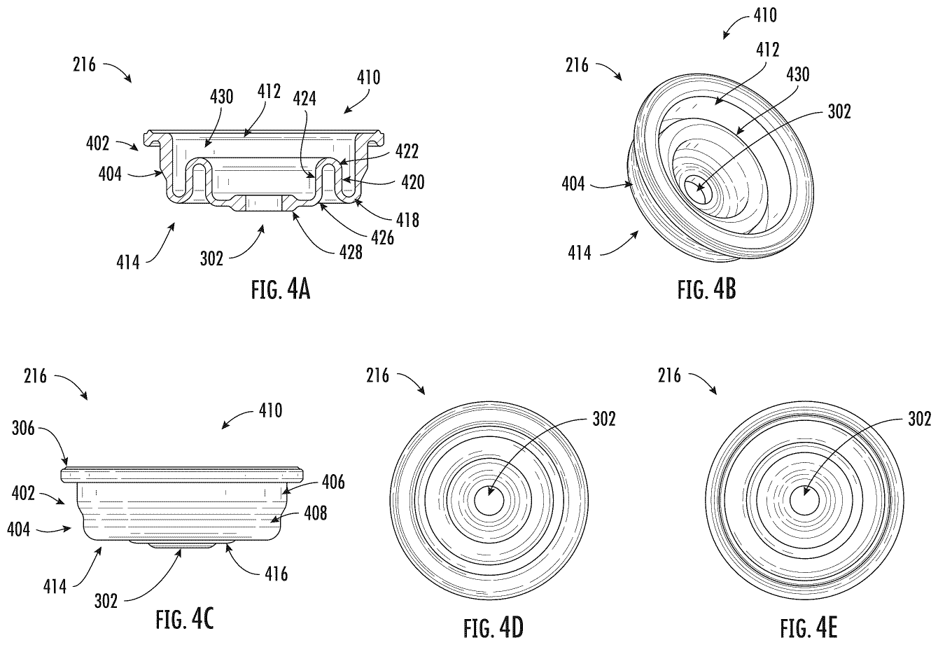

FIG. 4A through FIG. 4E are views of the example diaphragm 216. In the illustrated example embodiment, the diaphragm 216 has a generally cylindrical body 402 defined by an exterior side wall 404 extending between a top and a bottom of the diaphragm 216. An upper portion 406 of the body 402 has a first radius and a lower portion 408 of the body 402 has a second radius smaller than the first radius. The top flange 306 extends radially outwardly from the top 410 of the body 402. The body 402 defines an interior cavity 412 and the top 410 is open to the cavity 412.

The bottom 414 of the body 402 is partially closed by a bottom cover 416 defining the opening 302. The bottom cover 416 includes an upwardly arcing section 418 extending inward from a bottom of the exterior side wall 404 of the body 402 and arcing upwardly to a first interior side wall 420 spaced radially inward from the exterior side wall 404 by a distance defined by a radius of the upwardly arcing section 418. The first interior side wall 420 extends upwardly in a radial direction to a downwardly arcing section 422 extending inward from a top of the first interior side wall 420 to a second interior side wall 424 spaced radially inward from the first interior side wall 420 by a distance defined by a radius of the downwardly arcing section 422.

The second interior side wall 424 extends downwardly to an interior arcing section 426 extending from a bottom of the second interior side wall 424 and radially inward to central section 428 having a width greater than the width of the of the first interior side wall 420, the second interior side wall 424, the upwardly arcing section, the downwardly arcing section and the interior arcing section. The central section 428 defines the opening 302 through which the plunger 214 passes.

The bottom cover 416 thus includes an interior cylindrical undulation 430 defined by the first interior side wall 420, the second interior side wall 424, the upwardly arcing section 418, the downwardly arcing section 422 and the interior arcing section 426. The undulation 430 is positioned between the exterior side wall 404 of the body 402 and central section 428 defining the opening 302. Measured from the bottom of the central section 428, the undulation 430 has a height lower than the exterior side wall 404 of the body 402 and higher than the height of the central section 428.

The diaphragm 216 may be formed of an elastomeric material having a durometer of between about 50-70 on the Shore A scale. The hardness of the diaphragm 216 may vary, however, depending upon the design and size of the diaphragm 216, as well as the application of the solenoid valve 100. A diaphragm 216 according to the present disclosure may be formed from any suitable elastic material, e.g., an elastomer. Exemplary elastomers may include, for example, Viton ™ elastomer available from DuPont Dow Elastomers, nitrile elastomers, epichlorohydrin elastomer, e.g., Hydrin™ available from Zeon Chemicals, as well as numerous other elastomeric materials.

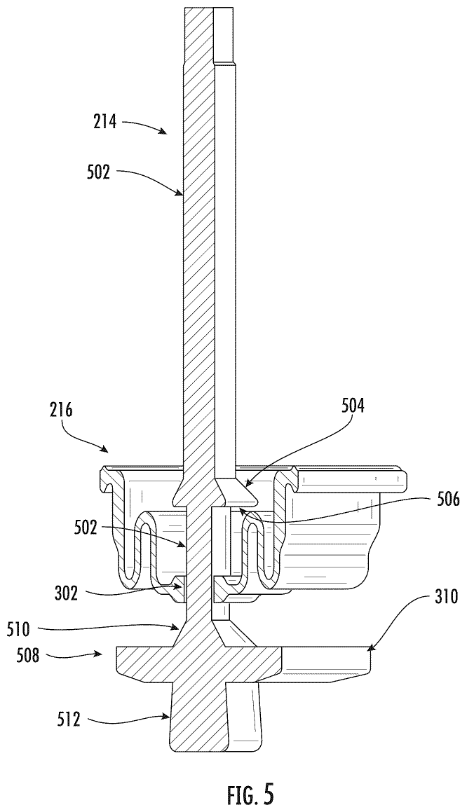

FIG. 5 is a perspective cross-sectional view of the plunger 214 and the diaphragm 216. As shown, the plunger 214 includes a longitudinal shaft 502. The top of the longitudinal shaft 502 is coupled to the armature 206, as shown in FIG. 3. A first radially extending flange 504 tapers outwardly from the longitudinal shaft 502 in the direction of the planar bottom flange 310 to define a diaphragm contact surface 506 at a bottom thereof that extends outwardly and circumferentially around the longitudinal shaft 502. A lower portion of the longitudinal shaft 502 disposed between the diaphragm 216 and the diaphragm contact surface 506 and extends through the opening 302 in the diaphragm 216.

A bottom portion 508 of the plunger 214 may be a separate component attached to a bottom of the longitudinal shaft 502 to allow the shaft to be placed through the opening 302 in the diaphragm 216. In the illustrated example embodiment, the bottom portion 508 of the plunger 214 includes a second radially extending flange 510 that tapers outwardly relative to the longitudinal shaft 502 to meet a top surface of the planar bottom flange 310. In the deenergized state of the solenoid valve 100 as shown in FIGS. 3 and 5, the central section 428 and the opening 302 of the diaphragm 216 are between the first radially extending flange 504 and the bottom 508 of the plunger 214, and, in particular, between diaphragm contact surface 506 and the top of the second radially extending flange 510 in the bottom of the plunger 214. An extension 512 axially aligned with the longitudinal shaft 502 may extend downwardly relative to a bottom surface of the planar bottom flange 310 with the planar bottom flange 310 extending radially outward with respect to the extension 512.

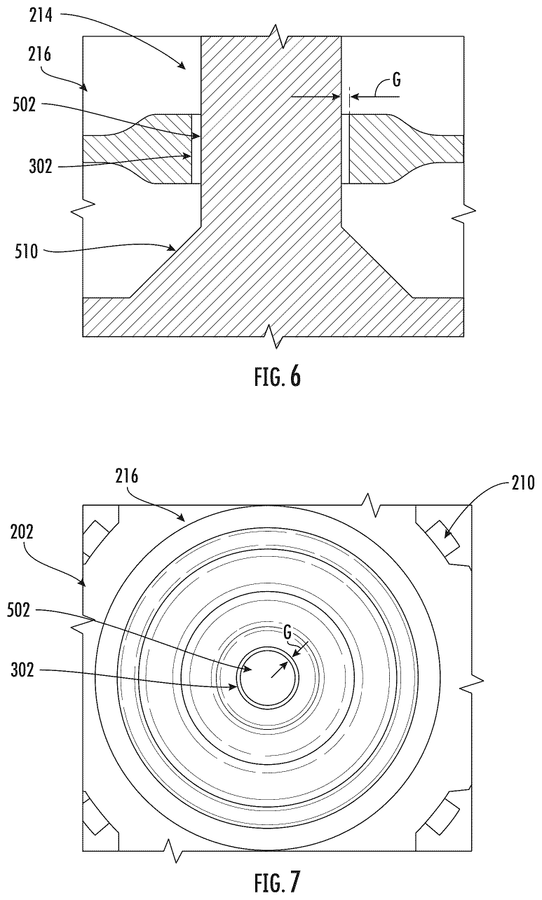

As shown particularly in FIGS. 6 and 7, the interior dimension, e.g., interior diameter, of the opening 302 may be larger than the outer dimension, e.g., outer diameter, of the longitudinal shaft 502 of the plunger 214. This establishes a gap G between the longitudinal shaft 502 of the plunger 214 and the opening 302, which allows the longitudinal shaft 502 move freely within the opening 302 in an axial direction without contacting the diaphragm 216. The size of the gap G may be any suitable size to allow free movement of the longitudinal shaft 502 of the plunger 214 in the opening 302. In some example embodiments, the gap may be about 0.10 to 0.20 millimeters (mm), and in some embodiments may be about 0.15 mm.

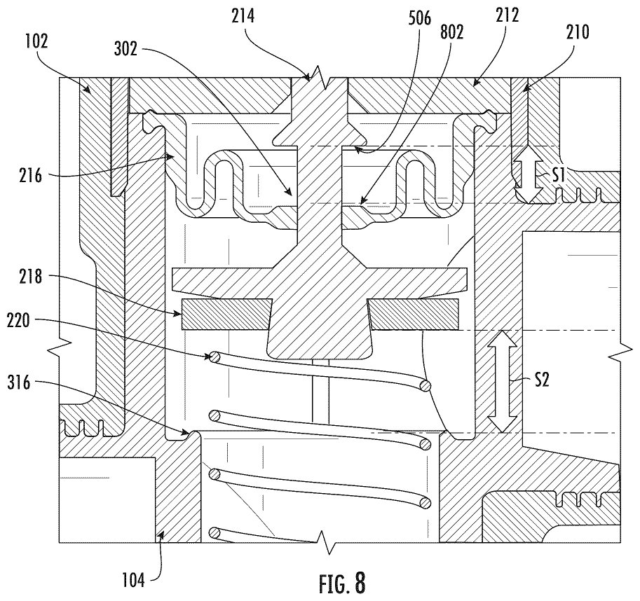

Turning now to FIG. 8, when the solenoid valve 100 is energized the plunger 214 moves downwardly toward the valve seat 316. Due to the gap G (FIGS. 6 and 7) between the longitudinal shaft 502 of the plunger 214 and the opening 302, the longitudinal shaft 502 of the plunger 214 moves freely relative to the diaphragm 216 without contacting the diaphragm 216 in a first portion S1 of the stroke of the plunger 214 until the diaphragm contact surface 506 contacts the top 802 of the central section 428 of the diaphragm 216. This first portion S1 of the stroke is defined by a distance between the diaphragm contact surface 506 and the top of the central section 428 when the solenoid valve 100 is deenergized. The first portion S1 of the stroke be any suitable length depending on the application and configuration of the solenoid valve 100. In some example embodiments, the first portion S1 of the stroke may be about 2-4 mm, and in some embodiments may be about 3.06 mm.

With reference also to FIG. 9, after the first portion S1 of the stroke, the diaphragm contact surface 506 contacts the top 802 of the central section 428 of the diaphragm 216. Engagement of the diaphragm contact surface 506 with the top 802 of the central section 428 prevents the plunger 214 from passing through the opening 302 and applies a force to the diaphragm 216 in the direction of travel of the plunger 214, i.e. toward the valve seat 316. The force applied by the plunger 214 causes the diaphragm 216 to elastically deform with the second interior side wall 424 stretching downwardly toward the valve seat 316. In some embodiments, due to the configuration of the undulation 430 in the bottom cover 416 of the diaphragm 216 the second interior side wall 424 stretches downwardly to a greater extent than the first interior side wall 420.

The elastic resistance, or spring constant, of the diaphragm 216 resists deformation of the diaphragm 216 in the direction of travel of the plunger 214. The resistance to deformation provided by the diaphragm 216 decreases the speed of travel of the plunger 214 toward the valve seat 316. The decrease in the speed of the plunger 214 as the plunger 214 approaches the valve seat 316 reduces the speed of impact and/or the impact force of the seal 218 against the valve seat 316 during closing of the solenoid valve 100. The reduction in speed and/or force of impact between the seal 218 and the valve seat 316 reduces audible noise resulting from the seal 218 closing against the valve seat 316.

The extent of deformation of the diaphragm 216 during travel of the plunger 214, i.e., the deformation stroke, may be selected depending on the application. and configuration of the solenoid valve 100. As shown in FIG. 8 the working stroke S2 of the plunger 214 may be measured from a bottom of the seal 218 to the valve seat 316. In some embodiments, the working stroke S2 may be about 4-6 mm, and in some embodiments may be about 5.36 mm. The deformation stroke of the diaphragm 216 may be about 2-3 mm, and some embodiments about 2.3 mm.

When the solenoid valve 100 is deenergized, the plunger 214 is forced upwardly away from the valve seat 316 and toward the open position by the compression spring 220. The spring constant of the compression spring 220 is selected to move the plunger 214 upwardly at a faster rate than a rate at which the diaphragm 216 can elastically recover from the deformation caused by the downward stroke of the plunger 214. In some embodiments, for example, the spring 220 and the diaphragm 216 may be configured such that the spring 220 moves the plunger 214 upwardly at a rate of about 1.5 to 3 times faster than the rate at which the diaphragm 216 can recover from the deformation when the seal 218 is seated on the valve seat 316, as shown in FIG. 9, to the position of the diaphragm 216 in the deenergized state shown in FIG. 3.

Initially, as the spring 220 forces the plunger 214 upward away from the valve seat 316 the longitudinal portion of the plunger 214 moves freely upward relative to the diaphragm 216 without contacting the diagram due to the gap G. However, since the recovery rate of the diaphragm 216 is slower than the rate at which the plunger 214 is moved upwardly by the spring 220, the second radially extending flange 510 of the plunger 214 contacts the central section 428 of the diaphragm 216, thus causing a downward force on the plunger 214. This downward force on the plunger 214 decreases the speed of upward travel of the plunger 214 and the armature 206 coupled to the top of the plunger 214 as the armature 206 approaches the top of the bobbin 202. The decrease in the speed of the armature 206 reduces the speed of impact and/or the impact force of the armature 206 against the top of the bobbin 202 during opening of the solenoid valve 100. The reduction in speed and/or force of impact between the armature 206 and the top of the bobbin 202 reduces audible noise resulting from the armature 206 contacting the top of the bobbin 202.

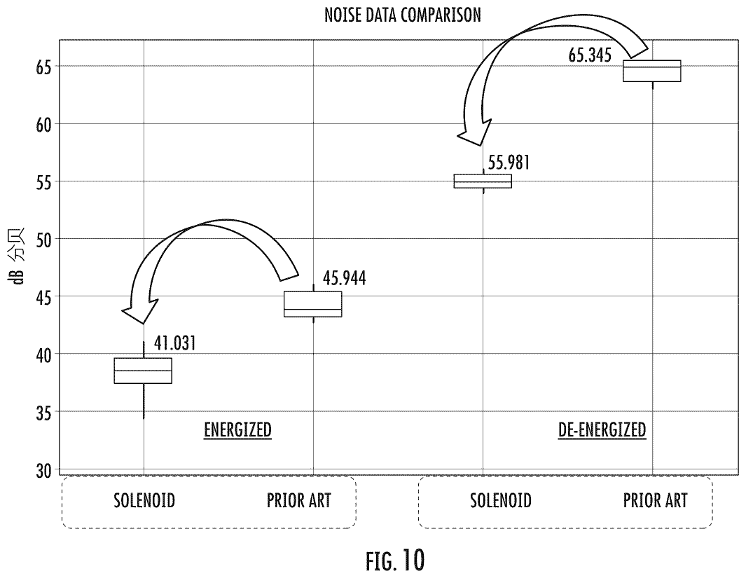

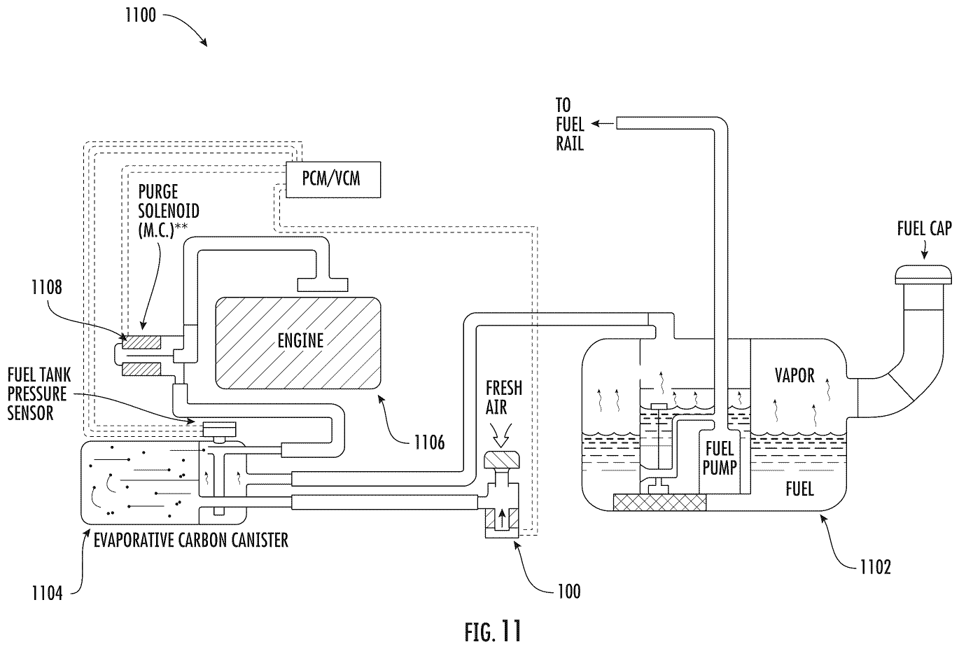

FIG. 10 includes plots of the sound level in decibels (db) for both a solenoid valve 100 including a diaphragm 216 consistent with the present disclosure (labeled “Solenoid” in FIG. 10) and a prior art solenoid valve without a diaphragm consistent with the present disclosure (labeled “Prior Art” in FIG. 10) in both energized and deenergized states. In the illustrated example, a solenoid valve 100 consistent with the present disclosure generates a sound level of 41.031 dB resulting from contact of the seal 218 with the valve seat 316 when the solenoid valve 100 is energized, whereas the prior art solenoid valve generates a sound level of 45.944 dB resulting from contact of the seal with the valve seat when the prior art solenoid valve is energized. When deenergized, a solenoid valve 100 consistent with the present disclosure generates a sound level of 55.981 dB resulting from contact of the armature 206 with the top of the bobbin 202, whereas the prior art solenoid valve generates a sound level of 63.345 dB resulting from contact of the armature with the top of the bobbin. A solenoid valve 100 consistent with the present disclosure thus generates significant noise reduction in both energized and deenergized states of the solenoid valve 100 compared to prior art solenoids.

A solenoid valve 100 consistent with the present application may be used in any application where noise reduction is required. In one example embodiment, a solenoid valve 100 consistent with the present disclosure may be used as a canister vent solenoid (CVS) valve in a fuel vapor recovery system of a motor vehicle. As is known, an internal combustion engine includes a fuel tank containing fuel for combustion in the engine. A fuel vapor recovery system includes an evaporative emissions canister for receiving fuel vapors generated in the fuel tank. A fuel vapor absorbent, typically activated charcoal, located in the evaporative emissions canister retains the fuel vapor when the vapors are displaced from the fuel tank during refilling. During operation of the engine, the fuel vapor contained in the evaporative emissions canister is purged by drawing fresh air through the canister. The CVS allows for the flow of the fresh air in the system.

Referring to FIG. 11, for example, illustrates one example embodiment of an evaporative emissions system 1100 including a CVS configured as a solenoid valve 100 consistent with the present disclosure. As shown, fuel vapors from the fuel tank 1102 may travel to the evaporative emissions canister 1104, which may serve as a storage device for fuel vapors. The evaporative emissions canister 1104 may contain a medium, such as activated carbon, which may collect the fuel vapors to prevent the vapor from being emitted into the atmosphere. During normal operation of the vehicle, the fuel vapors collected by the evaporative emissions canister 1104 may be released to the engine 1106 and may be consumed by the engine 1106.

The evaporative emissions canister 1104 may be coupled to the fuel tank 1102 by a canister purge valve 1108, and the evaporative emissions canister 1104 may be coupled the CVS 100, a port of which is coupled to atmospheric air for receiving fresh air into the CVS. Outputs from a purge control module (PCM), which may be part of a vehicle control module (VCM), cause the canister purge valve 1108 and the CVS 100 to open and close to achieve a desired operation of the system.

The canister purge valve 1108 controls the passage of fuel vapor from the evaporative emissions canister 1104 to the engine 1106. For example, during normal engine operating conditions, the fuel vapors stored in the evaporative emissions canister 1104 may be provided to the engine 1106. The PCM may cause the canister purge valve 1108 to open, or remain open, during normal operating conditions to allow the passage of fuel vapor from the evaporative emissions canister 1104 to the engine 1106. A vacuum from the intake manifold may draw the fuel vapor from the evaporative emissions canister 1104 to the engine 1106, where the fuel vapor may mix with air in the intake manifold to be consumed by the engine 1106.

The CVS 100 may be normally open to allow the flow of air into the evaporative emissions canister 1104. During normal engine operating conditions, the PCM cause the CVS 100 to open or remain open. As a result, air drawn into the evaporative emissions canister 1104 may flow through the canister medium and canister purge valve 1108 allowing the fuel vapor stored in the evaporative emissions canister 1104 to be delivered to the engine 1106.

In addition to controlling air flow into the evaporative emissions canister 1104 during normal engine operating conditions, the CVS 100 may control the flow of air from the evaporative emissions canister 1104. For example, during fueling or elevated temperatures, fuel vapor may flow from the fuel tank 1102 and into the evaporative emissions canister 1104 as a result of the increased pressure within the fuel tank 1102. After at least a portion of fuel vapor has been extracted by the canister medium, the air may flow from the evaporative emissions canister 1104 and out through the CVS 100, allowing the pressure in the fuel tank 1102 to be reduced. The CVS 100 may be closed during diagnostic testing of the evaporative emissions system 1100, etc.

According to one aspect of the present disclosure, there is thus provided a solenoid valve including: a bobbin configured to support a coil; an armature movably disposed relative to the bobbin; a valve body having a first port and a second port and defining a valve seat; a plunger, a top of the plunger being coupled to the armature, the plunger including a longitudinal shaft and a first radially extending flange extending radially relative to the longitudinal shaft and between top of the plunger and a bottom of the plunger, the plunger being movable with the armature between a closed position wherein fluid communication from the first port to the second port is blocked and an open position wherein fluid communication from the first port to the second port is allowed; a spring coupled to the plunger for biasing the plunger to the open position; and a diaphragm, the diaphragm being elastomeric and having an opening therethrough for receiving the longitudinal shaft with the longitudinal shaft being spaced from the opening by a gap to allow the longitudinal shaft to freely move within the opening, the opening being disposed between the first radially extending flange and the bottom of the plunger. The first radially extending flange is positioned to contact the diaphragm as the plunger is moved to the closed position and after a first portion of a stroke of the plunger in which the longitudinal shaft moves freely through the opening, whereby contact of the diaphragm by the first radially extending flange causes elastic deformation of the diaphragm in the direction of the valve seat to reduce a speed of travel of the plunger as the plunger is moved to the closed position. The spring is configured to force the plunger to the open position a rate faster than a rate at which the diaphragm recovers from the elastic deformation, whereby the plunger contacts the diaphragm to reduce a speed of travel of the plunger as the plunger is moved to the open position.

According to another aspect of the disclosure, there is provided a solenoid valve including: a bobbin configured to support a coil; an armature movably disposed relative to the bobbin; a valve body having a first port and a second port and defining a valve seat; a plunger, a top of the plunger being coupled to the armature, the plunger including a longitudinal shaft and a first radially extending flange extending radially relative to the longitudinal shaft and between top of the plunger and a bottom of the plunger and a second radially extending flange extending radially relative to the longitudinal shaft between the first radially extending flange and the bottom of the plunger, the plunger being movable with the armature between a closed position wherein fluid communication from the first port to the second port is blocked and an open position wherein fluid communication from the first port to the second port is allowed; a seal coupled to the plunger, the seal being engaged with the valve seat when the plunger is in the closed position and away from the valve seat when the plunger is in the open position; a spring coupled to the plunger for biasing the plunger to the open position; and a diaphragm, the diaphragm being elastomeric and having an opening therethrough for receiving the longitudinal shaft with the longitudinal shaft being spaced from the opening by a gap to allow the longitudinal shaft to freely move within the opening, the opening being disposed between the first radially extending flange and the second radially extending flange. The diaphragm includes an exterior side wall extending between a top and a bottom of the diaphragm, and a bottom cover. The top of the diaphragm is open and the bottom cover partially closes the bottom of the diaphragm. The bottom cover includes a central section defining the opening and defining an undulation between the exterior side wall and the opening. The exterior side wall has a first height, the undulation has a second height and the central section has a third height, the first height being greater than the second height and the second height being greater than the third height. The first radially extending flange is positioned to contact the diaphragm as the plunger is moved to the closed position and after a first portion of a stroke of the plunger in which the longitudinal shaft moves freely through the opening, whereby contact of the diaphragm by the first radially extending flange causes elastic deformation of the diaphragm in the direction of the valve seat to reduce a speed of travel of the plunger as the plunger is moved to the closed position. The spring is configured to force the plunger to the open position a rate faster than a rate at which the diaphragm recovers from the elastic deformation, whereby the second radially extending flange contacts the diaphragm to reduce a speed of travel of the plunger as the plunger is moved to the open position.

According to another aspect of the disclosure, there is provided an evaporative emission system including: an evaporation canister coupled to a fuel tank for receiving fuel vapor from the fuel tank; and a canister vent valve fluidly coupled to atmospheric air and the evaporation canister. The canister vent valve includes: a bobbin configured to support a coil; an armature movably disposed relative to the bobbin; a valve body having a first port and a second port and defining a valve seat; a plunger, a top of the plunger being coupled to the armature, the plunger including a longitudinal shaft and a first radially extending flange extending radially relative to the longitudinal shaft and between top of the plunger and a bottom of the plunger, the plunger being movable with the armature between a closed position wherein fluid communication from the first port to the second port is blocked and an open position wherein fluid communication from the first port to the second port is allowed; a spring coupled to the plunger for biasing the plunger to the open position; and a diaphragm, the diaphragm being elastomeric and having an opening therethrough for receiving the longitudinal shaft with the longitudinal shaft being spaced from the opening by a gap to allow the longitudinal shaft to freely move within the opening, the opening being disposed between the first radially extending flange and the bottom of the plunger. The first radially extending flange is positioned to contact the diaphragm as the plunger is moved to the closed position and after a first portion of a stroke of the plunger in which the longitudinal shaft moves freely through the opening, whereby contact of the diaphragm by the first radially extending flange causes elastic deformation of the diaphragm in the direction of the valve seat to reduce a speed of travel of the plunger as the plunger is moved to the closed position. The spring is configured to force the plunger to the open position a rate faster than a rate at which the diaphragm recovers from the elastic deformation, whereby the plunger contacts the diaphragm to reduce a speed of travel of the plunger as the plunger is moved to the open position.

Unless otherwise stated, use of the word “substantially” may be construed to include a precise relationship, condition, arrangement, orientation, and/or other characteristic, and deviations thereof as understood by one of ordinary skill in the art, to the extent that such deviations do not materially affect the disclosed methods and systems.

The term “coupled” as used herein refers to any connection, coupling, link, or the like by which signals carried by one system element are imparted to the “coupled” element. Such “coupled” devices, or signals and devices, are not necessarily directly connected to one another and may be separated by intermediate components or devices that may manipulate or modify such signals. Likewise, the terms “connected” or “coupled” as used herein in regard to mechanical or physical connections or couplings is a relative term and does not require a direct physical connection. Elements, components, modules, and/or parts thereof that are described and/or otherwise portrayed through the figures to communicate with, be associated with, and/or be based on, something else, may be understood to so communicate, be associated with, and or be based on in a direct and/or indirect manner, unless otherwise stipulated herein.

Throughout the entirety of the present disclosure, use of the articles “a” and/or “an” and/or “the” to modify a noun may be understood to be used for convenience and to include one, or more than one, of the modified noun, unless otherwise specifically stated. The terms “comprising”, “including” and “having” are intended to be inclusive and mean that there may be additional elements other than the listed elements. The phrase “at least one of A and B” should be understood to mean “only A, only B, or both A and B.”

Spatially relative terms, such as “beneath,” below,” upper,” “lower,” “above”, “left”, “right” and the like may be used herein for ease of description to describe one element or feature's relationship to another element(s) or feature(s) as illustrated in the drawings. These spatially relative terms are intended to encompass different orientations of the device in use or operation in addition to the orientation shown in the drawings. For example, if the device in the drawings is turned over, elements described as “below” or “beneath” other elements or features would then be oriented “above” the other elements or features. Thus, the exemplary term “below” may encompass both an orientation of above and below. The device may be otherwise oriented (rotated 90 degrees or at other orientations) and the spatially relative descriptors used herein interpreted accordingly.

Although the terms “first,” “second,” “third” etc. may be used to describe various elements, components, regions, layers and/or sections, these elements, components, regions, layers and/or sections are not to be limited by these terms as they are used only to distinguish one element, component, region, layer or section from another element, component, region, layer or section. Thus, a first element, component, region, layer, or section could be termed a second element, component, region, layer, or section without departing from the scope and teachings of the present invention.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention, which is not to be limited except by the following claims.

What is claimed is:

1. A solenoid valve comprising:
a bobbin configured to support a coil;
an armature movably disposed relative to the bobbin;
a valve body having a first port and a second port and defining a valve seat;
a plunger, a top of the plunger being coupled to the armature, the plunger comprising a longitudinal shaft and a first radially extending flange extending radially relative to the longitudinal shaft and between top of the plunger and a bottom of the plunger, the plunger being movable with the armature between a closed position wherein fluid communication from the first port to the second port is blocked and an open position wherein fluid communication from the first port to the second port is allowed;
a spring coupled to the plunger for biasing the plunger to the open position; and
a diaphragm, the diaphragm being elastomeric and having an opening therethrough for receiving the longitudinal shaft with the longitudinal shaft being spaced from the opening by a gap to allow the longitudinal shaft to freely move within the opening, the opening being disposed between the first radially extending flange and the bottom of the plunger,
the first radially extending flange being positioned to contact the diaphragm as the plunger is moved to the closed position and after a first portion of a stroke of the plunger in which the longitudinal shaft moves freely through the opening, whereby contact of the diaphragm by the first radially extending flange causes elastic deformation of the diaphragm in the direction of the valve seat to reduce a speed of travel of the plunger as the plunger is moved to the closed position, and
the spring being configured to force the plunger to the open position a rate faster than a rate at which the diaphragm recovers from the elastic deformation, whereby the plunger contacts the diaphragm to reduce a speed of travel of the plunger as the plunger is moved to the open position.

2. A solenoid valve according to claim 1, wherein the plunger comprises a second radially extending flange extending radially relative to the longitudinal shaft between the first radially extending flange and the bottom of the plunger, the opening being disposed between the first radially extending flange and the second radially extending flange, whereby the second radially extending flange contacts the diaphragm to reduce the speed of travel of the plunger as the plunger is moved to the open position.

3. A solenoid valve according to claim 1, wherein the plunger is configured to move to the closed position when the solenoid valve is in an energized state and to the open position when the solenoid valve is in a deenergized state.

4. A solenoid valve according to claim 1 further comprising a seal coupled to the plunger, the seal being engaged with the valve seat when the plunger is in the closed position and away from the valve seat when the plunger is in the open position.

5. A solenoid valve according to claim 4, wherein the plunger comprises a planar bottom flange extending radially outward relative to the longitudinal shaft, and the seal is coupled to the bottom of the planar bottom flange.

6. A solenoid valve according to claim 1, wherein the diaphragm comprises: an exterior side wall extending between a top and a bottom of the diaphragm, and a bottom cover, the top of the diaphragm being open and the bottom cover partially closing the bottom of the diaphragm, the bottom cover comprising a central section defining the opening.

7. A solenoid valve according to claim 6, wherein the bottom cover defines an undulation between the exterior side wall and the opening.

8. A solenoid valve according to claim 7, wherein the undulation comprises a first interior side wall between the exterior side wall and the opening and a second interior side wall between the first interior side wall and the opening.

9. A solenoid valve according to claim 7, wherein the exterior side wall has a first height, the undulation has a second height and the central section has a third height, the first height being greater than the second height and the second height being greater than the third height.

10. A solenoid valve according to claim 1 wherein the diaphragm is generally cylindrical.

11. A solenoid valve comprising:
a bobbin configured to support a coil;
an armature movably disposed relative to the bobbin;
a valve body having a first port and a second port and defining a valve seat;
a plunger, a top of the plunger being coupled to the armature, the plunger comprising a longitudinal shaft and a first radially extending flange extending radially relative to the longitudinal shaft and between top of the plunger and a bottom of the plunger and a second radially extending flange extending radially relative to the longitudinal shaft between the first radially extending flange and the bottom of the plunger, the plunger being movable with the armature between a closed position wherein fluid communication from the first port to the second port is blocked and an open position wherein fluid communication from the first port to the second port is allowed;
a seal coupled to the plunger, the seal being engaged with the valve seat when the plunger is in the closed position and away from the valve seat when the plunger is in the open position;
a spring coupled to the plunger for biasing the plunger to the open position; and
a diaphragm, the diaphragm being elastomeric and having an opening therethrough for receiving the longitudinal shaft with the longitudinal shaft being spaced from the opening by a gap to allow the longitudinal shaft to freely move within the opening, the opening being disposed between the first radially extending flange and the second radially extending flange, the diaphragm comprising:
an exterior side wall extending between a top and a bottom of the diaphragm: and
a bottom cover,
the top of the diaphragm being open and the bottom cover partially closing the bottom of the diaphragm,
the bottom cover comprising a central section defining the opening and defining an undulation between the exterior side wall and the opening,
the exterior side wall having a first height, the undulation having a second height and the central section having a third height, the first height being greater than the second height and the second height being greater than the third height,
the first radially extending flange being positioned to contact the diaphragm as the plunger is moved to the closed position and after a first portion of a stroke of the plunger in which the longitudinal shaft moves freely through the opening, whereby contact of the diaphragm by the first radially extending flange causes elastic deformation of the diaphragm in the direction of the valve seat to reduce a speed of travel of the plunger as the plunger is moved to the closed position, and
the spring being configured to force the plunger to the open position a rate faster than a rate at which the diaphragm recovers from the elastic deformation, whereby the second radially extending flange contacts the diaphragm to reduce a speed of travel of the plunger as the plunger is moved to the open position.

12. An evaporative emission system comprising:
an evaporation canister coupled to a fuel tank for receiving fuel vapor from the fuel tank; and
a canister vent valve fluidly coupled to atmospheric air and the evaporation canister; the canister vent valve comprising:
a bobbin configured to support a coil;
an armature movably disposed relative to the bobbin;
a valve body having a first port and a second port and defining a valve seat;
a plunger, a top of the plunger being coupled to the armature, the plunger comprising a longitudinal shaft and a first radially extending flange extending radially relative to the longitudinal shaft and between top of the plunger and a bottom of the plunger, the plunger being movable with the armature between a closed position wherein fluid communication from the first port to the second port is blocked and an open position wherein fluid communication from the first port to the second port is allowed;
a spring coupled to the plunger for biasing the plunger to the open position; and
a diaphragm, the diaphragm being elastomeric and having an opening therethrough for receiving the longitudinal shaft with the longitudinal shaft being spaced from the opening by a gap to allow the longitudinal shaft to freely move within the opening, the opening being disposed between the first radially extending flange and the bottom of the plunger,
the first radially extending flange being positioned to contact the diaphragm as the plunger is moved to the closed position and after a first portion of a stroke of the plunger in which the longitudinal shaft moves freely through the opening, whereby contact of the diaphragm by the first radially extending flange causes elastic deformation of the diaphragm in the direction of the valve seat to reduce a speed of travel of the plunger as the plunger is moved to the closed position, and
the spring being configured to force the plunger to the open position a rate faster than a rate at which the diaphragm recovers from the elastic deformation, whereby the plunger contacts the diaphragm to reduce a speed of travel of the plunger as the plunger is moved to the open position.

13. The evaporative emission system according to claim 12, wherein the plunger comprises a second radially extending flange extending radially relative to the longitudinal shaft between the first radially extending flange and the bottom of the plunger, the opening being disposed between the first radially extending flange and the second radially extending flange, whereby the second radially extending flange contacts the diaphragm to reduce the speed of travel of the plunger as the plunger is moved to the open position.

14. The evaporative emission system according to claim 12, wherein the plunger is configured to move to the closed position when the canister vent valve is in an energized state and to the open position when the canister vent valve is in a deenergized state.

15. The evaporative emission system according to claim 12 further comprising a seal coupled to the plunger, the seal being engaged with the valve seat when the plunger is in the closed position and away from the valve seat when the plunger is in the open position.

16. The evaporative emission system according to claim 15, wherein the plunger comprises a planar bottom flange extending radially outward relative to the longitudinal shaft, and the seal is coupled to the bottom of the planar bottom flange.

17. The evaporative emission system according to claim 12, wherein the diaphragm comprises: an exterior side wall extending between a top and a bottom of the diaphragm, and a bottom cover, the top of the diaphragm being open and the bottom cover partially closing the bottom of the diaphragm, the bottom cover comprising a central section defining the opening.

18. The evaporative emission system according to claim 17, wherein the bottom cover defines an undulation between the exterior side wall and the opening.

19. The evaporative emission system according to claim 18, wherein the undulation comprises a first interior side wall between the exterior side wall and the opening and a second interior side wall between the first interior side wall and the opening.

20. The evaporative emission system according to claim 18, wherein the exterior side wall has a first height, the undulation has a second height and the central section has a third height, the first height being greater than the second height and the second height being greater than the third height.
